(19) United States
(12) Patent Application Publication
(10) Pub. No.: US 2004/0215414 A1
(43) Pub. Date: Oct. 28, 2004

(54) Method and apparatus for measuring and machining workpieces

(76) Inventor: Han-Jurgen Kaisser, Donzdorf (DE)

Correspondence Address: HEAD, JOHNSON & KACHIGIAN, 228 W 17TH PLACE, TULSA, OK, 74119, US

(21) Appl. No.: 10/312,137

(22) PCT Filed: Jun. 19, 2001
(86) PCT No.: PCT/EP01/06923

(30) Foreign Application Priority Data
Jun. 19, 2000 (DE) 10030087.1

(51) Int. Cl. G06F 19/00; G01C 19/00

(52) U.S. Cl. 702/104

(57) ABSTRACT

A method and an apparatus for cutting machining of workpieces with rotationally symmetrical, in particular eccentrically rotationally symmetrical surfaces, in particular the big-end bearing locations of crankshafts, in which contour checking, in particular roundness checking of workpieces and possibly also the stroke height of big-end bearing journals of crankshafts is effected quickly and accurately and the operation of ascertaining correction values for the tools and angular association thereof is very simple, wherein by means of a measuring sensor the maximum actual spacing of the workpiece contour to be measured in a measuring direction from a reference value, for example the turning center, is ascertained for each measurement angular position of the workpiece, the measured deviation between the actual spacing and the reference spacing is ascertained for each measurement angular position, and at least for the measurement angular positions the respective tool reference positions are automatically corrected by a correction value which is automatically calculated from the respective measured deviation.

### I. FIELD OF USE

The invention concerns the cutting machining of workpieces with rotationally symmetrical, in particular eccentrically rotationally symmetrical, surfaces, for example the big-end bearing locations on crankshafts.

### II. TECHNICAL BACKGROUND

Crankshafts are comparatively unstable workpieces by virtue of their multiply cranked shape.

As the production costs and therewith a machining time which is as short as possible are in the foreground in terms of machining crankshafts in large numbers, the obvious tendency is to complete the necessary removal of material by means of cutting machining as quickly as possible. That generally means that the machining forces increase. At the same time however it is necessary to observe the required tolerances, for example in regard to deviation from roundness, in particular in relation to the big-end bearing locations but also in regard to the central bearing locations.

Theoretically establishing the maximum permissible machining forces and therewith the machining parameters is only partly possible so that checking of the deviation from roundness and possibly also the stroke height on the machined workpiece are always additionally required, and, in comparison with the permissible tolerances, correction of the machining parameters is necessary.

That problem occurs in relation to big-end bearing locations in particular if machining of the big-end bearing locations is implemented for example by means of milling and with the crankshaft being clamped in a central relationship, in which the milling tool is caused to track the respective eccentrically rotating big-end bearing location in the transverse direction.

In that respect it is already known for the deviations from roundness of the machined crankshaft to be established in a measurement laboratory, that is to say after the crankshaft has been released from its condition of being clamped in the machine tool. In that situation two difficulties arise at the same time: on the one hand the detected deviations from roundness must be previously precisely related to the respective angular position of the crankshaft in the machine tool, and equally the correction values which are to be established in order in future to improve the roundness of the crankshaft.

In addition the crankshaft suffers deformation solely due to being released as supporting/clamping the crankshaft in position in the measurement laboratory is fundamentally different from in the machine for machining it.

It is further known for a measuring apparatus to be arranged directly in the machine so that the crankshaft can be measured in respect of roundness and possibly additionally in respect of stroke, in the condition of being clamped in the machine tool.

In that case, a measuring arm is pivoted to the crankshaft about a pivot axis which extends parallel to the longitudinal axis of the crankshaft. The measuring arm carries a prism which is moved towards the crankshaft until it bears against for example the bearing surface to be measured. Then, the spacing of the surface of the workpiece relative to the bottom of the prism is measured with a measuring sensing device which is provided in the intermediate angle of the measuring prism in the apparatus.

That procedure is carried out in a plurality of angular positions of the bearing surface to be measured.

In order to be able to carry this out in relation to eccentrically rotating surfaces, for example a big-end bearing surface, the degree of cantilever extension of the pivot arm therefore also has to be altered in each case. For that purpose the pivot arm comprises two arm portions which in turn are pivotable relative to each other.

However, that not only alters the position of the angle of impingement of the measuring prism on the workpiece surface to be measured, which increases the difficulty of determining correction values and in particular the association thereof with a given angular position of the workpiece in the machine. In addition, each of the pivot axes of the measuring apparatus involves play, which has an adverse influence on the level of accuracy of the measurement result.

### III. STATEMENT OF THE INVENTION

a) Technical Object

Therefore the object in accordance with the present invention is to provide a method and an apparatus in which the contour checking operation, in particular the roundness checking operation, in respect of workpieces and optionally also the stroke height of big-end bearing journals of crankshafts, is carried out quickly and accurately, and it is very simple to ascertain correction values for the tools and provide for angular association thereof.

b) Attainment of the Object

That object is attained by the characterising features of claims 1, 5 and 6. Advantageous embodiments are set forth in the appendant claims.

By virtue of the fact that the distance of a point on the workpiece contour which is to be measured, from a reference value, is only ever ascertained in a given direction, but this is done in relation to a plurality of angular positions of the workpiece, it is possible to comparatively easily calculate the actual contour of the workpiece from the measurement values and also to determine the position of that actual contour with respect to the center of rotation. Correspondingly, it is also possible to ascertain correction values for the tool movements. As in this case the measuring apparatus is fixed directly to the tool support, in particular directly to the main body of the tool, it is not possible for any inaccuracies to occur, which would occur by virtue of the measuring apparatus being fixed to another part of the machine tool, than the tool support.

As in that case the workpiece can remain in the clamped position for machining, there is no unwanted influence due to its being released and re-clamped.

Therefore, in regard to the big-end bearing locations of a crankshaft, the actual contour is determined, and accordingly not just the deviation from roundness thereof but also the deviation thereof from the reference stroke.

A further advantage is that the crankshaft which has already been machined can in that way be post-machined once again with the corrected tool settings, at a low level of cost, as in fact the workpiece is kept in the clamped condition.

By virtue of the simple association of the correction values with the angular positions of the workpiece, it is also possible at low cost to ascertain a correction value for angular positions between measured measurement angular positions, by means of interpolation, and to use that interpolated correction value in future, and thereby to additionally improve the degree of roundness.

By virtue of the fact that the measuring apparatus is arranged directly at the tool support, the play which is present in relation to the tool supports in the X-direction and possibly in the Y-direction is also involved in the measurement result. It is not necessary to take account of play present in the slide systems in different ways, on the one hand in relation to the measuring apparatus and on the other hand in relation to the tool unit.

For the same reason, the measuring sensor for example in the form of a measuring surface, is preferably also arranged in the same radial plane as the tool, for example the milling cutter, between the tool and the workpiece. Preferably, positioning is effected on the connecting line between the tool center point and the workpiece center point in that radial plane, wherein the measuring surface is of such a large extent transversely and preferably at a right angle relative to the measuring direction and transversely and in particular at a right angle relative to the longitudinal axis of the workpiece that, in all angular positions, the eccentric surface to be measured can be sensed by the measuring surface.

It will be appreciated that it is necessary for that purpose that the configuration of the measuring surface relative to the measuring direction is precisely known, in respect of its angular position, that is to say, when a right-angled arrangement is involved, that right angle is exactly observed.

Furthermore the precise distance of the measuring surface from the tool support or a fixed point of the tool support is necessary.

If the tool used is not a rotating tool such as a milling disk but a stationary tool such as for example a turning bit, the measuring sensor and in particular the measuring surface thereof is arranged on the connecting line between the workpiece, preferably the workpiece center point, and the cutting edge.

Basically in that case an arrangement of the measuring surface as close as possible to the tool is to be preferred.

In addition it should be ensured that the measuring sensor bears against the workpiece in the measuring operation with a defined force which preferably does not exceed a given maximum value but which also does not fall below a given minimum value, in particular to avoid twisting of the arm of the measuring apparatus, which would immediately falsify the measurement result.

In this case, the measuring direction can be directed radially with respect to the center or the center of curvature of the rotationally symmetrical workpiece surface to be measured, which is the case in particular when the measuring sensor has a measuring surface whose length corresponds to the entire region of eccentricity of the surface, with respect to the C-axis. The measuring direction however may also be a tangential direction or a direction which is displaced radially inwardly with respect to the tangential direction and in which the measuring sensor is moved past the workpiece, and thereby is pressed by the workpiece surface radially outwardly with respect to the center of the surface to be measured. For that purpose, the measuring sensor can be fixed to the measuring apparatus either pivotably or linearly movably, and in particular there can be two mutually oppositely disposed measuring sensors on a measuring apparatus, in order to be able to simultaneously measure two oppositely disposed points of the workpiece surface, in a single measuring operation.

c) Embodiments

An embodiment according to the invention is described in greater detail hereinafter by way of example with reference to the Figures in which:

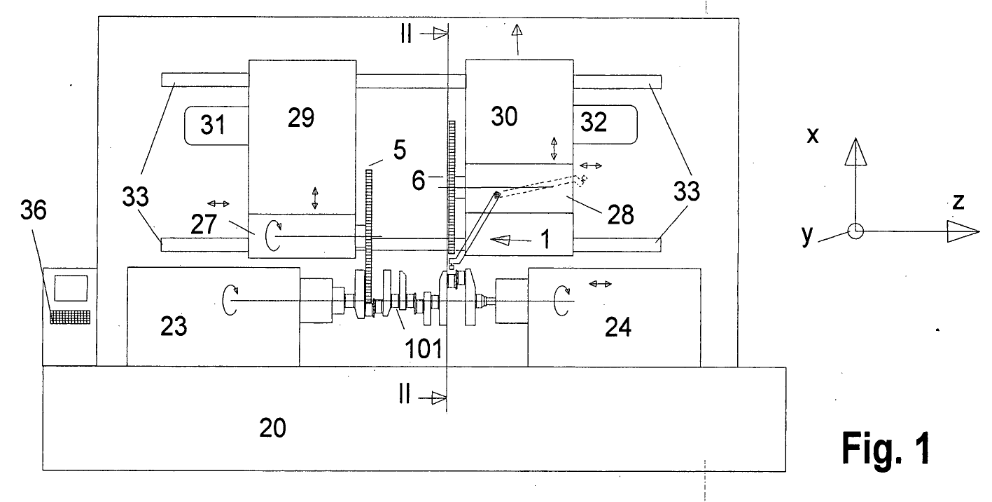

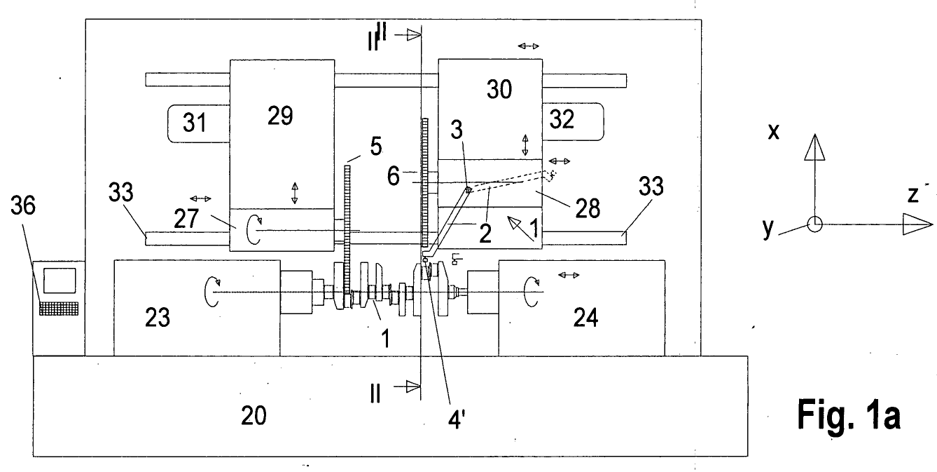

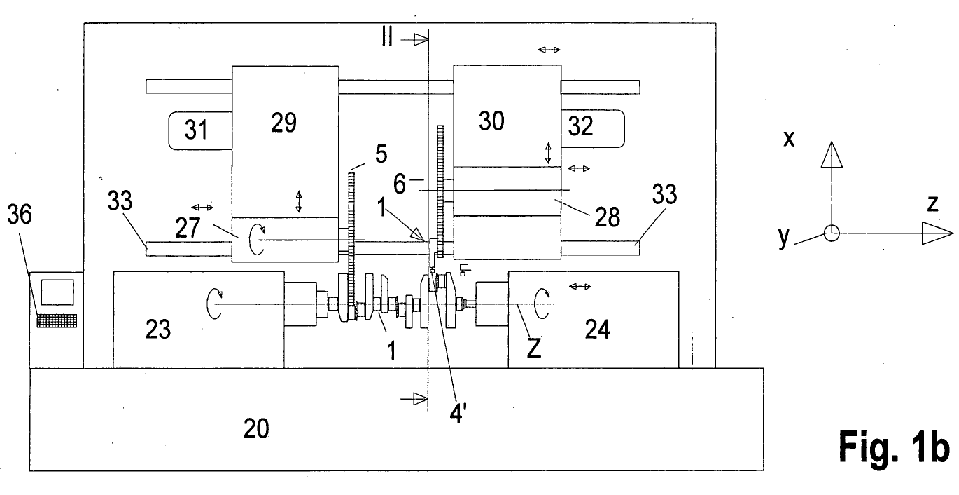

FIG. 1a shows a front view of a machine tool according to the invention with measuring apparatus,

FIG. 1b shows the same view of the machine tool of FIG. 1a with another measuring apparatus,

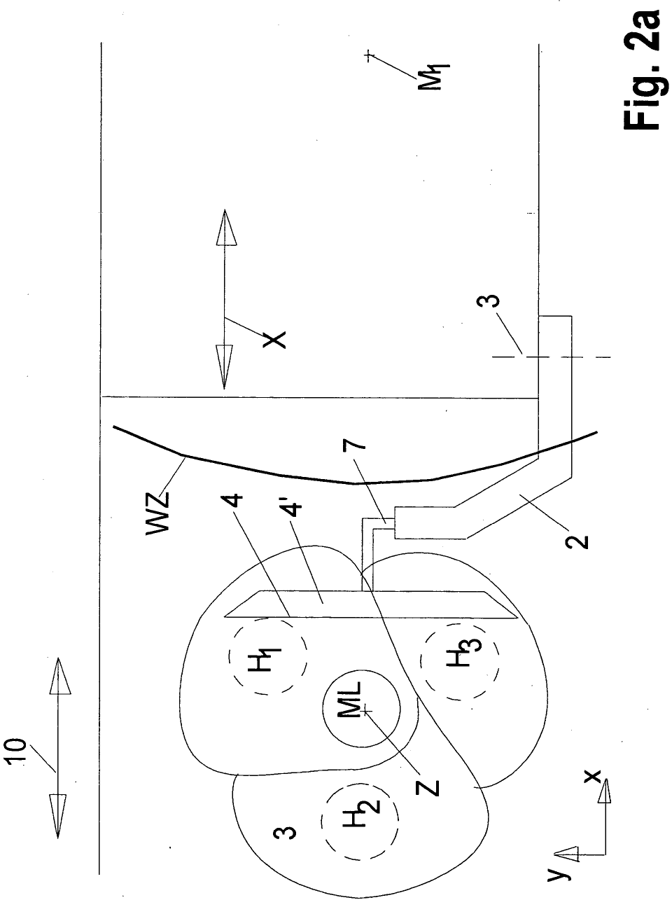

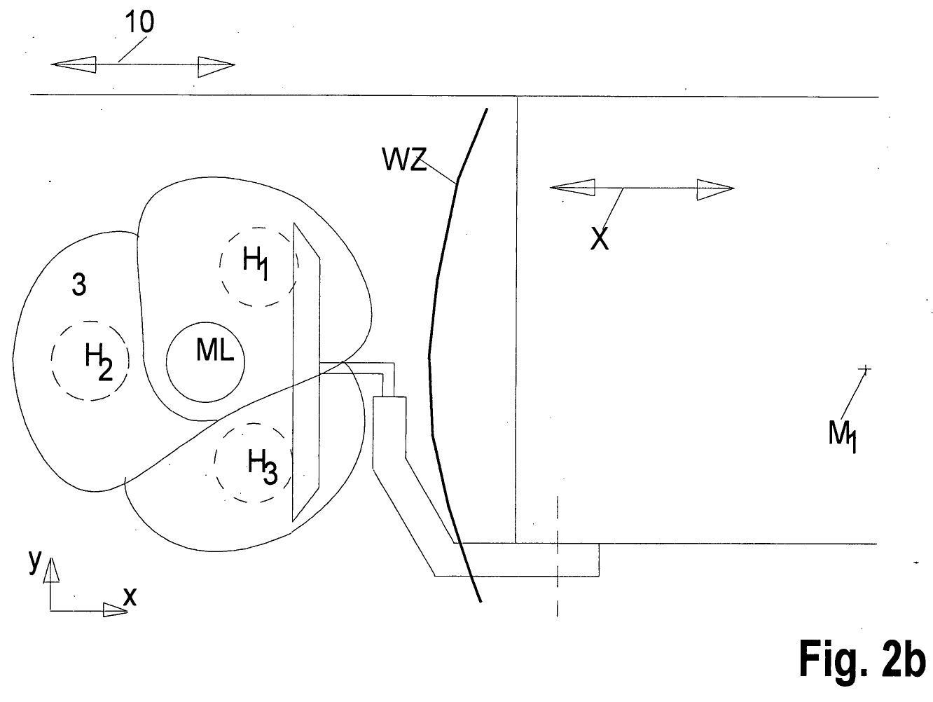

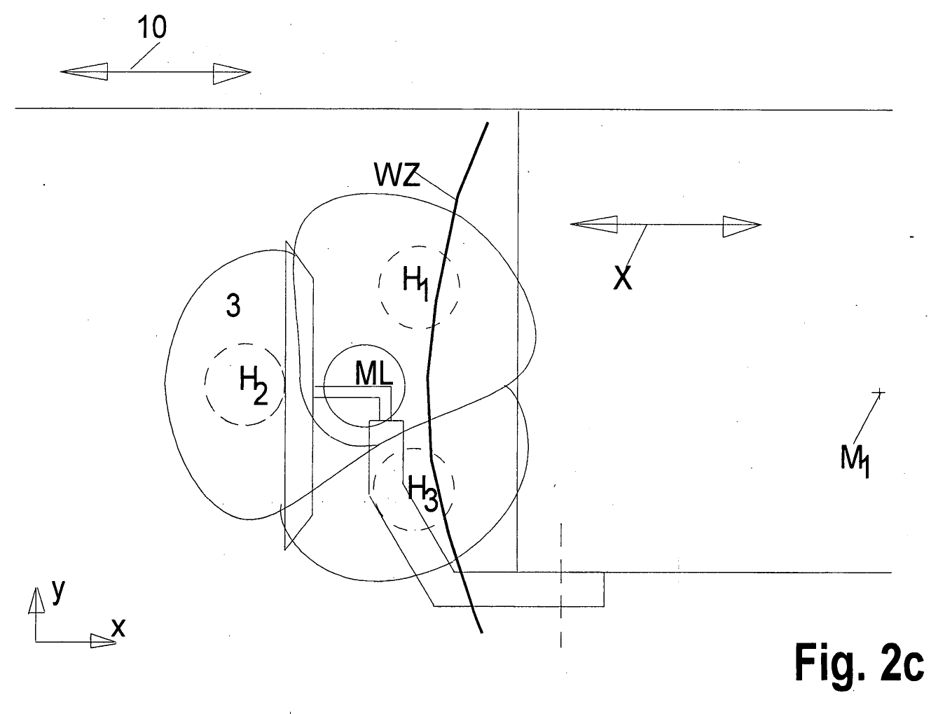

FIGS. 2a-2c show detail views of the measuring apparatus taken along line II-II,

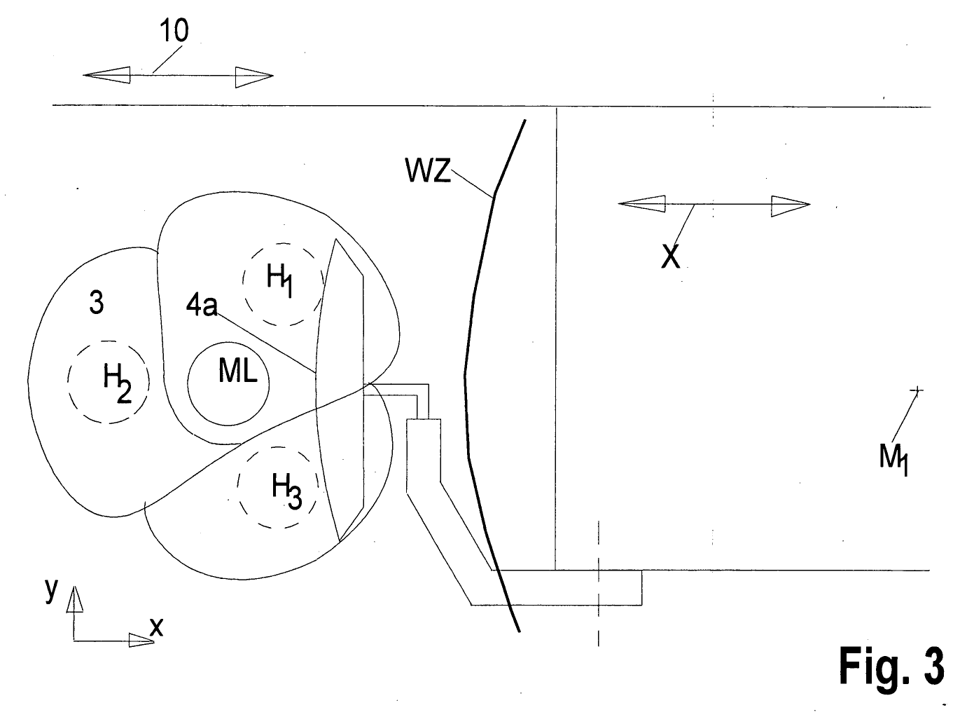

FIG. 3 is a view similar to FIG. 2,

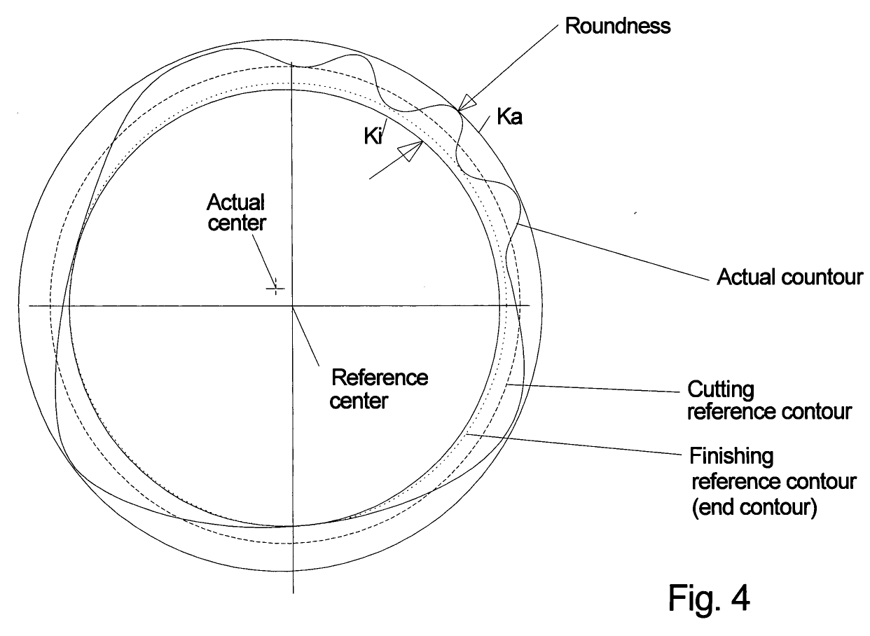

FIG. 4 is a view in section through the rotationally symmetrical surface to be measured,

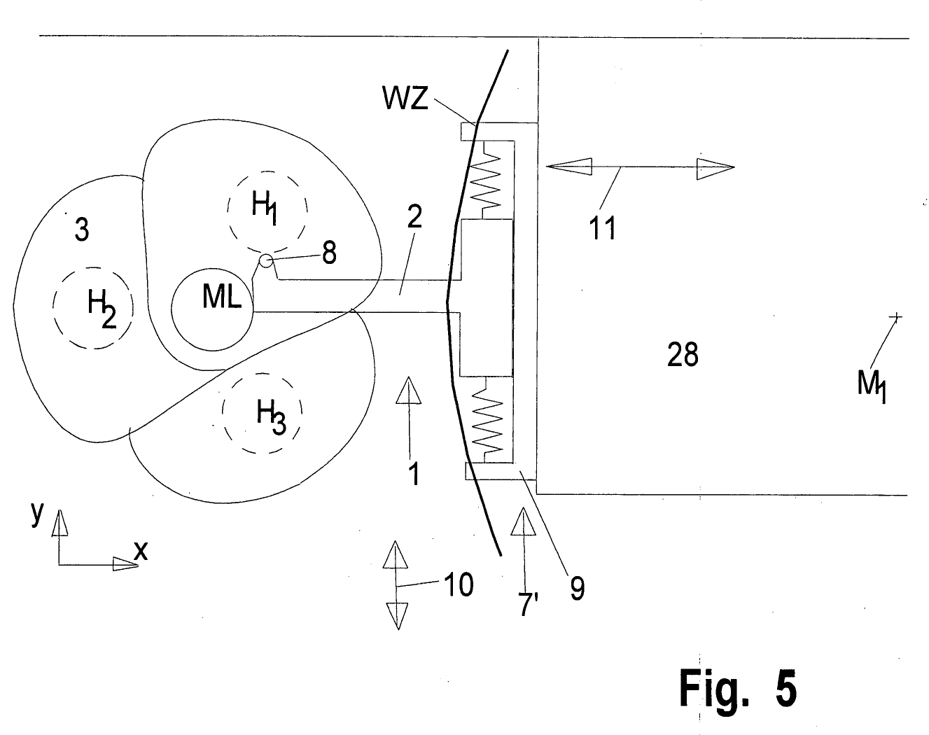

FIG. 5 is a detail view of another measuring apparatus,

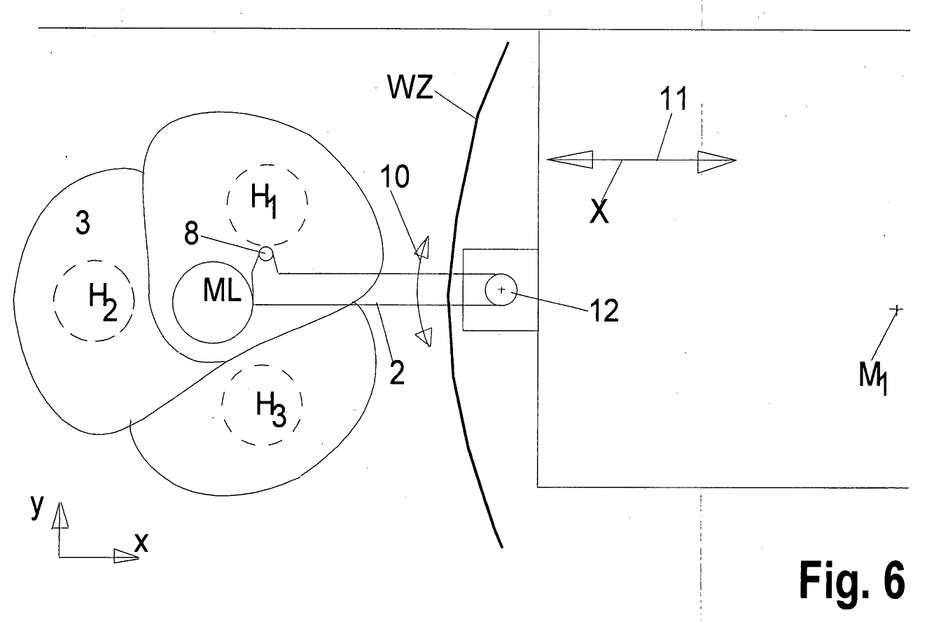

FIG. 6 is a detail view of a further embodiment of the measuring apparatus, and

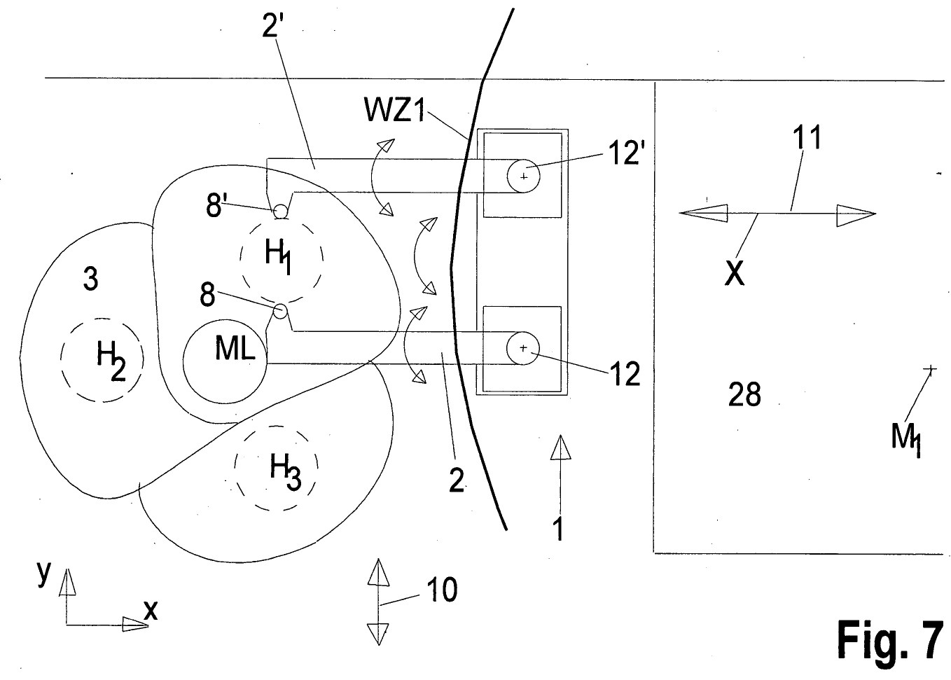

FIG. 7 is a detail view of a twin measuring apparatus.

FIG. 1 shows a crankshaft milling machine viewing in the Y-direction, that is to say horizontally and transversely with respect to the longitudinal extent (Z-direction of the crankshaft).

The crankshaft is received with its two ends, that is to say on its main bearing axis, in chucks 21, 22 which are component parts of the synchronously drivable headstocks 23, 24.

The headstocks 23, 24 are arranged on the bed 20 and can be displaceable in the Z-direction for receiving crankshafts of different lengths.

The machine tool has two separate machining units 25, 26 which each include a Z-slide 29, 30 which is displaceable along longitudinal guides 33 in the Z-direction.

A respective X-slide 27, 28 is arranged displaceably in the X-direction on each of the Z-slides 29, 30.

Arranged on the mutually associated ends of the X-slides 27, 28 are respective milling disks 5, 6 which are driven in rotation, for example by means of respective motors 31, 32.

Positional and motion parameters of both the crankshaft 1 and also the tool units 5, 6 are controlled by way of a machine control 35. The corresponding parameters can be altered by way of an input unit, for example a keyboard 36.

In this arrangement the milling disks 5, 6, that is to say the tool units, are displaceable only in one transverse direction, namely the X-direction, with respect to the workpiece 1.

During the machining operation the crankshaft, that is to say the workpiece 1, rotates slowly about the Z-axis while the respective rotatingly driven milling disk 5, 6 is in operation at one of the big-end bearings, for example H₁, or also at one of the center bearings ML.

When operating at a big-end bearing H, the eccentricity of the big-end bearings means that a continuous tracking movement of the milling cutter 5 and 6 respectively in the X-direction is necessary, in accordance with the instantaneous rotational position of the workpiece 1. In a corresponding manner, the contact point between the tool and the workpiece does not always lie exactly at the height of the plane defined by the center of the milling cutter on the one hand and the axis of rotation of the workpiece on the other hand, but, depending on the respective rotational position of the crankshaft, is also above or below that plane.

FIG. 1 shows the left-hand tool unit 25 in operation, wherein therefore the milling disk 5 is performing the milling operation at the big-end bearing location H₁. In that situation, in the plunge phase of operation, the milling disk 5 can also have already milled the adjoining crankshaft web cheek side surface. Preferably the width of the milling disk 5—as measured in the Z-direction—approximately corresponds to the width of the bearing location to be machined.

While FIG. 1 shows a measuring apparatus 1 as is described in greater detail hereinafter only at the right-hand machining unit 26, each of the machining units can be provided with such a measuring apparatus, in practice and for cost reasons and to avoid additional calibration procedures in general only one measuring apparatus will be provided at only one machining unit.

The measuring apparatus 1 in FIG. 1a includes a measuring arm 2 which is displaceable between a working position and a rest position.

As the measuring arm 2 is arranged at the unit which directly carries the tool, in this case therefore the X-slide 28, displacement of the measuring arm is effected by pivotal movement about a pivot axis 3, with respect to the X-slide 28. In this case the pivot axis 3 extends transversely and preferably at a right angle relative to the axis of rotation of the crankshaft 1, that is to say the X-direction, and parallel or transversely and in particular at a right angle relative to the measuring surface 4 of the measuring sensor.

Therefore the measuring arm 2 is arranged pivotably on the side of the X-slide 28, which is towards the workpiece. Arranged at the free end of the cranked measuring arm 2 is a measuring bar 4′ with a measuring surface 4 which is towards the workpiece and which is connected to the measuring arm 2 by way of a sensor 7. The measuring bar 4 can therefore perform a positioning movement 11 in the X-direction, by means of the X-slide 28. The sensor 7 is capable of recording displacements of the measuring bar 4′ in the measuring direction 10 which is identical to the positioning movement 11, the X-direction.

In FIG. 1a the measuring apparatus 1 is shown in solid lines in the working position. In that case the measuring bar 4′ is disposed between the milling cutter 6 and the workpiece. By pivotal movement about the pivot axis 3 the measuring arm 2 and therewith the entire measuring apparatus 1 can be pivoted completely out of the working region of the milling cutter 6 into a rest position in which preferably the measuring bar 4′ is disposed on the side of the X-slide 28, which is remote from the milling disk 6.

FIG. 1b differs from FIG. 1a in that the measuring apparatus 1 is arranged not on the X-slide 28 but directly at for example the face of the rotating milling disk 6.

When the milling disk 6 is stationary therefore a positioning movement 11 can be implemented by means of the X-slide 28 in the X-direction. It will be noted that, by rotation of the milling disk 6 into a defined rotational position, a displacement of the measuring apparatus 1 in the Y-direction is additionally possible. The measuring apparatus in FIG. 1b again includes a measuring bar 4′, as described with reference to FIG. 1a, but it can also be of a different configuration, as described hereinafter.

FIG. 4 is a symbolic exaggerated view showing how the actual contour can deviate from the reference or target contour as should exist after the cutting procedure: the actual contour is not a complete circular contour but has long-wave or short-wave raised portions and recessed portions. An internal circle KI which is as large as possible can be fitted into that irregular actual contour and an external circle KA which is as small as possible can be applied to the outside thereof, which circles extend in mutually concentric relationship, and on the one hand determine the degree of out-of-round in the radial direction, and on the other hand the actual center of the existing workpiece contour which generally is not identical to the reference or target center.

It is precisely when ascertaining the actual stroke of the big-end bearing locations of crankshafts with respect to the reference or target stroke that the two influences are superimposed on each other, that is to say the out-of-round and the deviation of the actual center from the reference center.

FIGS. 2a-2c show how the measuring bar 4′ with its measuring surface 4— when the measuring apparatus 1 is in the working position—is moved towards the big-end bearing location H₁ to be measured, by displacement of the X-slide 28 in the measuring direction 10, for example the X-direction, which is implemented in succession in different measuring positions, that is to say rotational positions, of the crankshaft and therewith the big-end bearing location H₁:

In that situation in their Y-position the measuring bar 4′ with its measuring surface 4 is always in the same position.

Therefore, it is only in two rotational positions of the crankshaft 101 that the big-end bearing location H₁ is pressed against the measuring surface 4 at the center thereof at which it is mounted to the sensor 7.

In all other cases, the point of contact will be outside the center of the measuring surface 4, but the measuring sensor 7 will nonetheless ascertain the distance of the point of contact between the surface to be measured, for example the bearing surface of the big-end bearing H₁, and the measuring surface 4, from a defined point on the X-slide 28, for example the axis of rotation of the milling disk 6.

As in addition the machine control system also knows the position of the C-axis, that is to say the rotational position of the crankshaft 101, of the crankshaft 101 which in the measuring operation is not rotating but is stationary, and additionally also the X-position of the X-slide 28 when the surface to be measured is contacted by the measuring surface 4, it is possible—as in each case a different point of the peripheral surface of the big-end bearing journal A₁ is contacted by the measuring surface 4 depending on the respective angular position of the crankshaft—to ascertain for each individual measuring operation whether and how much the actual position of the measuring point deviates from the reference or target position which is on an exactly round reference contour.

It is possible to ascertain therefrom for each rotational position of the individual measuring locations, a correction value for the tool position, that is to say a value by which, with the crankshaft in that rotational position, the tool and therewith the X-slide 28 must be moved further or less far in the X-direction towards the workpiece in order to improve the roundness at that location.

The roundness of the rotationally symmetrical surface, in this case the big-end bearing journal H₁, can be improved in that way by producing correction values for each individual measurement position and even—by means of interpolation—by ascertaining correction values between the measurement positions.

It is possible to particularly easily ascertain the correction values if the measuring surface 4 is not a flat surface but is a surface which is curved in an arcuate configuration similarly to the tool contour and which is spaced in the measuring direction 10 from the tool contour by a given value—in the working position—, as is shown in FIG. 3 for a measurement position.

That has the advantage that, by virtue of the parallel positioning of the measuring surface 4a and the contour of the milling disk 6, the contact point of the measuring surface 4a at the big-end bearing journal 1 in the measurement procedure is the same contact point as in the machining operation by the milling cutter 6, with the crankshaft 101 in the same angular position. Therefore, for ascertaining the correction value, only the X-displacement between the measuring surface 4a and the milling disk 6 has to be taken into consideration.

FIGS. 5-7 show measuring apparatuses which differ from the structures in FIG. 2 in that here the measuring direction 10, that is to say the geometrical direction in which a measurement value is ascertained, is not identical to the positioning movement 11 in which the measuring apparatus 1 is moved for the purposes of carrying out the measuring procedure.

In the structure shown in FIG. 5 the measuring apparatus 1 is also fixed to the X-slide 28 and is moved by means thereof. The positioning movement 11 is therefore the same as the X-direction.

The measuring arm 2 which carries the measuring tip 8 is however displaceable along a guide 9 which is fixed to the X-slide 28 extending in the Y-direction. The guide 9 with sensors (not shown) arranged thereon therefore represents the measuring sensor 7′ which accordingly can also only detect displacements of the measuring arm 2 in the measuring direction 10 which is then the Y-direction. In a corresponding manner, the measuring arm 2 projects in cantilever fashion transversely with respect to the measuring direction 10, namely in the direction of the positioning movement 11, and the measuring tip 8 thereof projects therefrom transversely with respect to the measuring arm.

Therefore, by virtue of displacement of the measuring slide 28 in the X-direction, the measuring tip 8 of the measuring arm 2, if it encounters the contour of the for example big-end bearing journal H₁ to be measured, is pushed away by the contour thereof in the measuring direction 10 and thereby the point of greatest deflection of the measuring arm 2 in the measuring direction 10 is ascertained, with the workpiece in the rotational position on which that procedure is based. For determining a measurement value in different rotational positions of the workpiece at the same workpiece contour, it may be necessary to provide for different rough positioning of the measuring apparatus 1 on the tool unit in the Y-direction.

The approach movement of the measuring tip 8 in the direction of the positioning movement can take place when the workpiece, for example the crankshaft, is stationary, and thus can be effected a plurality of times when the crankshaft is stopped in different rotational positions.

The measuring operation however can also be carried out when the workpiece is rotating, for example when the crankshaft is rotating, in which case however the measuring tip 8 is required to perform a tracking movement in the direction of the positioning movement 11, with the workpiece surface to be measured, in the X-direction and possibly also roughly in the Y-direction. By virtue of that procedure, admittedly it is possible on the one hand to measure the entire periphery of the contour to be measured, but there could be the disadvantage that the point which is not always highest in the measuring direction 10 is measured, for example because there was a previously unknown deviation in respect of roundness or position of eccentricity, of the surface to be measured.

The structure shown in FIG. 6 differs from that of FIG. 5 in that in this case the measuring arm 2 is not linearly displaceable but is pivotable with respect to a pivot axis 12 which extends transversely with respect to the positioning movement 11 and parallel to the Z-axis. The resulting measuring direction of the measuring tip 8 is thus also not a linear movement but an arcuate movement. On the basis of the pivot angle of the measuring arm 2—which like the measuring arm 2 in FIG. 6 is also biased into a zero or neutral position—it is also possible to determine the measurement value, namely the point of the big-end bearing location H₁, which projects furthest—in this case in the negative Y-direction—, for which purpose obviously the position of the measuring tip 8 must be known in relation to the pivot axis 12 in terms of distance and angle in the rest position.

FIG. 7 shows a structure similar to FIG. 6, which deviates therefrom in two essential points: on the one hand the measuring apparatus 1 shown in FIG. 6 is of a duplicated nature here, in mirror-image configuration. The two measuring tips 8, 8′ are directed towards each other and are therefore capable of simultaneously measuring the two sides of a circular workpiece contour. Instead of using pivotable measuring arms 2, 2′, that would also be possible with linearly displaceable measuring arms as shown in FIG. 5.

In addition the measuring apparatus 1 is not fixed to the X-slide 28 but directly to the disk-shaped rotatable tool, for example the milling disk 6 shown in FIG. 1. In a corresponding fashion, by virtue of rotary movement of the tool WZ, it is also possible for the measuring apparatus 1 to be additionally displaced in its Y-position, which however also involves displacement of the angular position of the measuring arm 2 or 2′ respectively, with respect to its pivot axis 12 or 12′ respectively. Independently thereof, the positioning movement 11 is always the direction of movement of the slide carrying the unit, in this case the X-direction, by virtue of the X-slide 28.

Such a twinned structure halves the amount of time involved in measuring a rotationally symmetrical workpiece contour and in addition avoids re-positioning the entire measuring apparatus in another Y-position for example on the X-slide 28 in order to compensate for the variation in the Y-position of the big-end bearing journal to be measured, for example H₁, upon rotation of the crankshaft into the individual measurement positions.

List of References

1 measuring apparatus

2 measuring arm

3 pivot axis

4 measuring surface

4′ measuring bar

5 milling disk

6 milling disk

7 sensor

8 measuring tip

9 guide

10 measuring direction

11 positioning movement

12 pivot axis

13

14

15

16

17

18

19

20 bed

21 chuck

22 chuck

23 headstock

24 headstock

25 machining unit

26 machining unit

27 X-slide

28 X-slide

29 Z-slide

30 Z-slide

31 motor

21 motor

101 workpiece

1. A method of measuring workpieces with rotationally symmetrical, concentric or eccentric surfaces, and, in dependence thereon correcting the tool reference position with respect to the machine tool for a plurality of working points on the workpiece, said method comprising the following steps:
by means of a measuring sensor, only the maximum actual spacing of the workpiece contour to be measured from a reference value, is ascertained for each measurement angular position of the workpiece;
for each measurement angular position, the measured deviation between the actual spacing and the reference spacing is ascertained; and
at least for the measurement angular positions the respective tool reference position is automatically corrected by a correction value which is automatically calculated from the respective measured deviation.

2. A method as set forth in claim 1 wherein said workpiece remains in the machining clamping arrangement during the measurement procedure.

3. A method as set forth in claim 1 wherein correction values are additionally determined by means of interpolation for intermediate positions between the measurement angular positions and the correction operation is carried out.

4. A method as set forth in claim 1 wherein said measuring sensor is moved by means of a slide directly carrying the tool.

5. A method of cutting machining and measuring workpieces with rotationally symmetrical, concentric or eccentric surfaces, and, in dependence thereon correcting the tool reference position with respect to the machine tool for a plurality of working points on the workpiece, wherein said method includes the following steps:
by means of a measuring sensor, only the maximum actual spacing of the workpiece contour to be measured from a reference value, is ascertained for each measurement angular position of a workpiece;
for each measurement angular position, the measured deviation between the actual spacing and the reference spacing is ascertained;
at least for the measurement angular positions the respective tool reference position is automatically corrected by a correction value which is automatically calculated from the respective measured deviation; and
the tool is displaceable in one direction.

6. A machine tool, said machine tool comprising:
at least one spindle for receiving and rotationally driving a workpiece about an Z-axis on the center of rotation;
at least one machining unit for moving the tool at least in an X-direction in dependence on the rotational position of the workpiece spindle (C-axis); and
a measuring device.

7. A machine tool as set forth in claim 6 wherein said measuring device is arranged directly on the tool (WZ) of said tool support.

8. A machine tool as set forth in claim 6 wherein said measuring device is arranged directly on an X-slide which directly carries the tool (WZ).

9. A machine tool as set forth in claim 8 wherein said measuring device is fixed to said tool support and is automatically pivotably displaceable between a working position and a rest position.

10. A machine tool according to claim 6 including said measuring device having a measuring surface on a measuring bar and thus on a measuring sensor, which measuring surface is oriented at a right angle to said Z-axis and at a right angle to a measuring direction in said X-direction.

11. A machine tool according to claim 10 wherein said measuring sensor with said measuring surface is arranged in a defined fixed position with respect to the tool support in said measuring direction.

12. A machine tool as set forth in claim 6 wherein when using a milling disk as the tool, said measuring surface is arranged in the plane of the disk-shaped main body of the tool (WZ) or axially displaced in relation thereto, radially outwardly of the milling disk, in the working position.

13. A machine tool as set forth in claim 6 wherein with a pivotable measuring arm, the measuring arm is pivotable about a pivot axis which extends transversely with respect to the measuring direction and transversely with respect to the Z-direction.

14. A machine tool as set forth in claim 6 wherein the tool is a turning revolver turret or a turning broaching revolver turret and the measuring surface is arranged in the plane of the revolver turret radially outside the tools in the working position.

15. A machine tool as set forth in claim 10 wherein said measuring surface is shaped and arranged with its contour parallel to the outside contour of the associated tool, said outside contour facing in the measuring direction.

16. A method as set forth in claim 1 wherein the actual spacing of the workpiece contour to be measured is a big-end bearing surface in a measuring direction.

17. A method as set forth in claim 16 wherein said measuring direction is in an X-direction.

18. A method as set forth in claim 1 wherein said reference value is from a center of rotation.

19. A method as set forth in claim 1 wherein said measuring sensor is moved by means of the tool.

20. A method as set forth in claim 1 wherein said surface is a crankshaft.

21. A method as set forth in claim 5 wherein the actual spacing of the workpiece contour to be measured is a big-end bearing surface in a measuring direction.

22. A method as set forth in claim 20 wherein said measuring direction is in an X-direction.

23. A method as set forth in claim 5 wherein said surface is a crankshaft.

24. A method as set forth in claim 5 wherein said reference value is from a center of rotation.

25. A method as set forth in claim 5 wherein said tool is displaceable in the measuring direction or a positioning movement which is transverse with respect thereto.

26. A method as set forth in claim 6 wherein said measuring device is a roundness measuring device arranged directly on the tool support.
